(19) United States
(12) Patent Application Publication
(10) Pub. No.: US 2015/0000643 A1
(43) Pub. Date: Jan. 1, 2015

(54) LOCOMOTIVE BI-FUEL CONTROL SYSTEM

(71) Applicants: Jason Green, Miami, FL (US); Glenn Juber, Coral Springs, FL (US); Chert Nompone, SACHSE, TX (US)

(72) Inventors: Jason Green, Miami, FL (US); Glenn Juber, Coral Springs, FL (US); Chert Nompone, SACHSE, TX (US)

(21) Appl. No.: 14/295,969

(22) Filed: Jun. 4, 2014

Related U.S. Application Data
(60) Provisional application No. 61/830,698, filed on Jun. 4, 2013.

(51) Int. Cl. F02B 43/10; F02M 43/00

(52) U.S. Cl. CPC F02B 43/10; F02M 43/00; F02B 2043/103
USPC 123/526

(57) ABSTRACT

A system designed and structured to fully integrate LNG conversion solution for power plants associated with locomotives, which include, but are not limited to, General Electric AC 4400 and Dash-9 locomotive power plants.

### BACKGROUND OF THE INVENTION

1. Field of the Invention

This invention is directed to a system designed and structured to fully integrate LNG conversion solution for power plants associated with locomotives, which include, but are not limited to, General Electric AC 4400 and Dash-9 locomotive power plants.

2. Description of the Related Art

Typically locomotives as well as other heavy duty power plants are powered by either direct drive diesel or diesel electric power trains frequently including a multiple horse power turbo charged diesel engine.

Accordingly, it is well recognized that distillate fuels, specifically diesel, are used as the primary fuel source for such power plants. Attempts to maximize the operational efficiency, while maintaining reasonable safety standards, have previously involved modified throttle control facilities. These attempts serve to diminish adverse effects of control mechanisms which may be potentially harmful to the vehicle engine operation as well as being uneconomical. Typical adverse effects include increased fuel consumption and wear on operative components. Therefore, many diesel engines and the vehicles powered thereby are expected to accommodate various types of high capacity payloads and provide maximum power for relatively significant periods of operation. As a result, many diesel engines associated with locomotive are commonly operated at maximum or near maximum capacity resulting in an attempted maximum power delivery from the vehicle engine and consequent high rates of diesel consumption. It is generally recognized that the provision of a substantially rich fuel mixture in the cylinders of a diesel engine is necessary for providing maximum power when required. Such continued high capacity operation of the vehicle engine results not only in wear on the engine components but also in high fuel consumption rates, lower operating efficiencies, more frequent oil changes and higher costs of operation.

Accordingly, there is a long recognized need for a fuel control system specifically intended for use with high capacity, off-road vehicles including mine haul vehicles of the type generally described above that would allow the use of more efficient fueling methods using other commonly available fuel sources. Therefore, an improved fuel control system is proposed which is determinative of an effective and efficient operative fuel mixture comprised of a combination of gaseous and distillate fuels. More specifically, gaseous fuel can comprise natural gas or other appropriate gaseous type fuels, wherein distillate fuel would typically include diesel fuel.

Such a preferred and proposed fuel control system should be capable of regulating the composition of the operative fuel mixture on which the vehicle engine currently operates to include 100% distillate fuel, when the vehicle's operating mode(s) clearly indicate that the combination of gaseous and distillate fuels is not advantageous. Further, such a proposed fuel control system could have an included secondary function to act as a general safety system serving to monitor critical engine fuel system and chassis parameters. As a result, control facilities associated with such a preferred fuel control system should allow for discrete, user defined control and safety set points for various engine, fuel system and chassis parameters with pre-alarm, alarm and fault modes.

### SUMMARY OF THE INVENTION

The present invention is directed to a system designed as a fully integrated liquid natural gas (LNG) conversion solution for locomotive engines specifically including, but not limited to, the general electric AC 4400 and Dash-9 locomotives.

Moreover, the system of the present invention allows the converted locomotive to operate on a variable mixture of natural gas and diesel fuel will maintaining the performance, reliability and safety of the vehicle. The integrated system utilizes state-of-the-art controls to precisely optimize natural gas fueling rates across the low range of the 7 FDL power unit. In the event of either a system fault or loss natural gas supply, the system and the operating components in characteristics associated there with automatically and seamlessly reverts the locomotive power plant to 100% diesel operation regardless of load condition. Installation of the system of the present invention does not require significant modification of the locomotive engine or auxiliary systems including either the engine governing unit (EGU) or diesel injection system.

The conversion system of the present invention comprises an electronic control unit (ECU) designed to dynamically manage natural gas fueling rates of the engine based on a variety of inputs including RPM, throttle notch position, mass air flow, natural gas flow and alternator power. In addition, the ECU has a power supply that operates using locomotive power ranging from 40-90 VDC and is designed to provide clean power to its internal circuitry that is limited, filtered and transient protected from the vehicle power supply.

The system of the present invention also includes an operator display located in the locomotives operator cab, wherein the system of the present invention is adaptive to other display capabilities.

The system of the present invention also incorporates an integrated air-gas mixer. Low pressure natural gas is applied to the engine using a fumigation method whereby gaseous fuel is admitted upstream of the turbo compressor inlet using a fixed geometry air gas mixing device. Further, the system includes a proprietary mass airflow (MAF) sensor providing combustion air flow data to the ECU. MAF sensor data is utilized for gas mapping and control as well as for engine safety and is used by the ECU to ensure that the air gas mixture supplied to the engine remains below lower flammable limits (LFL).

In addition to the above system incorporates high and low pressure gas controls associated with a complete gas train comprising a manual shutoff valve as well as other operative components. The gas train utilizes and incorporates various pressure and temperature sensors that provide gas pressure and temperature data to the ECU.

In at least one embodiment of the present invention the system includes a comprehensive engine safety system designed to protect against damages relating to dual fuel operation. Also, the system and cooperates an operator safety system designed to protect personnel from hazards associated with the dual fuel operation.

Other structural and operative features of the system of the present invention also include the incorporation of a diesel oxidation catalyst; a fuel measurement system; a telematics sub-system, which may be associated with hardware I/O interface.

In addition to the above, the ECU provides appropriate and predetermined analog inputs; frequency inputs; digital inputs; thermocouple inputs. Operatively associated there with our analog outputs; power drive outputs; discrete outputs, etc. Further, the ECU provides non-volatile memory storage for coding calibration parameters, wherein the memory is sufficient to provide an estimated 70% reserve for future expansion. Further associated with the system it is the provision, by the ECU of operative communication links.

An important function of included power supply circuitry is to monitor the voltage supplied to the digital logic. On power-up, the power supply holds a microcontroller and all outputs in “reset” until the digital logic supply is stabilized and is within tolerances. This technique ensures a pretty microcontroller clocks and memory devices associated with the ECU are functional before the microcontroller starts to execute software.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of the system of the present invention may incorporate the electronic control unit (ECU).

FIG. 2 is a perspective view in schematic form of a display associated with the system of the present invention.

FIG. 3 is a perspective view of an air flow mixer.

FIG. 4 is a perspective view of a mass air flow sensor (MAF).

FIG. 5 is a perspective view of a gas train associated with the system and drivetrain of the power plant with which the system of the present invention is associated.

FIG. 6 is a perspective view of control circuitry which may incorporate the aforementioned ECU of the system of the present invention.

FIG. 7 is a schematic representation in block form of the operating characteristics and/or parameters of the system of the present invention in direct is association with operative hardware components.

FIG. 8 is a schematic representation of the engine and tender car vaporizer temperature control loop.

Like reference numerals refer to like parts throughout the several views of the drawings.

### DETAILED DESCRIPTION OF THE PREFERRED EMBODIMENT

The present invention is directed to a system (commercially recognized as EVO-LT 4400). Moreover, the system is designed as a fully integrated LNG conversion solution for specific power plants associated with locomotives. The system allows the converted locomotive to operate on a variable mixture of natural gas and diesel fuel while maintaining the performance, reliability and safety of the vehicle.

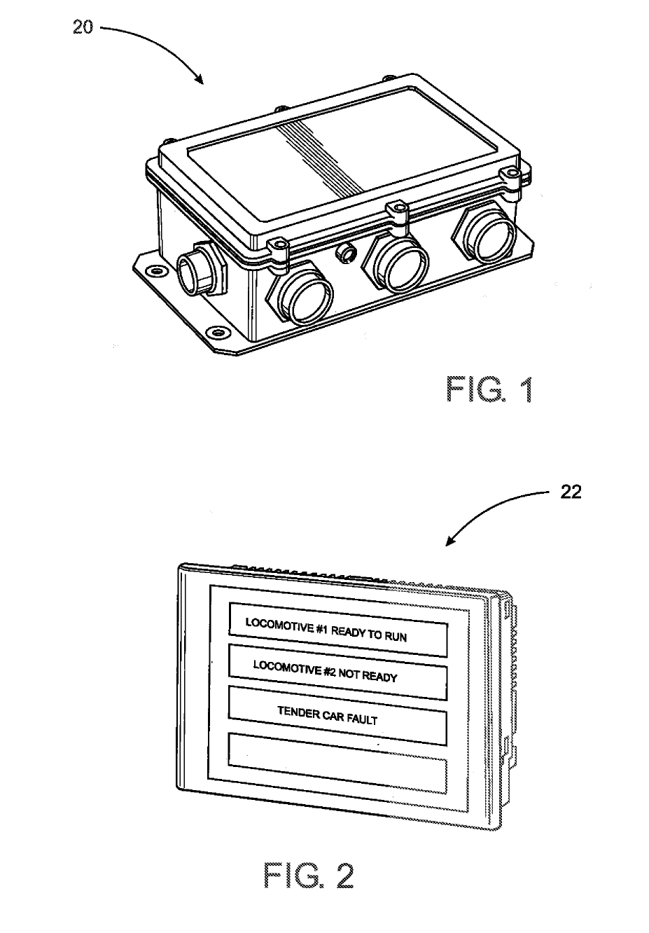

The system of the present invention incorporates an electronic control unit (ECU) generally represented as 20 in FIG. 1, which is designed to dynamically manage natural gas fueling rates to the converted engine based on a variety of inputs including RPM, throttle notch position, mass air flow, natural gas flow and alternator power. The ECU also monitors additional engine and vehicle parameters and provides pre-alarm, alarm, warning and fault modes signaling based on predefined conditions. The ECU provides the capability to decrease the gas substitution rate in response to critical parameters such as knock, vibration, MAP and EGT. In addition to gas mapping and control functionality, the ECU manages the locomotive fluid system and communicates with the LNG tender car through the train line signals or TL-20 Ethernet.

The ECU has a power supply that operates using locomotive power ranging from 40-90 VDC. It is designed to provide clean power to its internal circuitry that is limited, filtered and transient protected from the vehicle power supply. The ECU power grounds are electrically isolated from its enclosure to meet both safety and EMI design requirements. The ECU design incorporates internal power supplies that provide short circuit protection, thermal limiting, reverse voltage protection and load dump protection of the 200 V. The design also includes the necessary filtering components to minimize emissions, both conducted and radiated.

The system includes an operator display 22 as represented in FIG. 2. The display may be located in the locomotives operator cab. In order to save cost and installation time, the display 22 may be a commercially available industrial display/controller in the range of 6 inches in size.

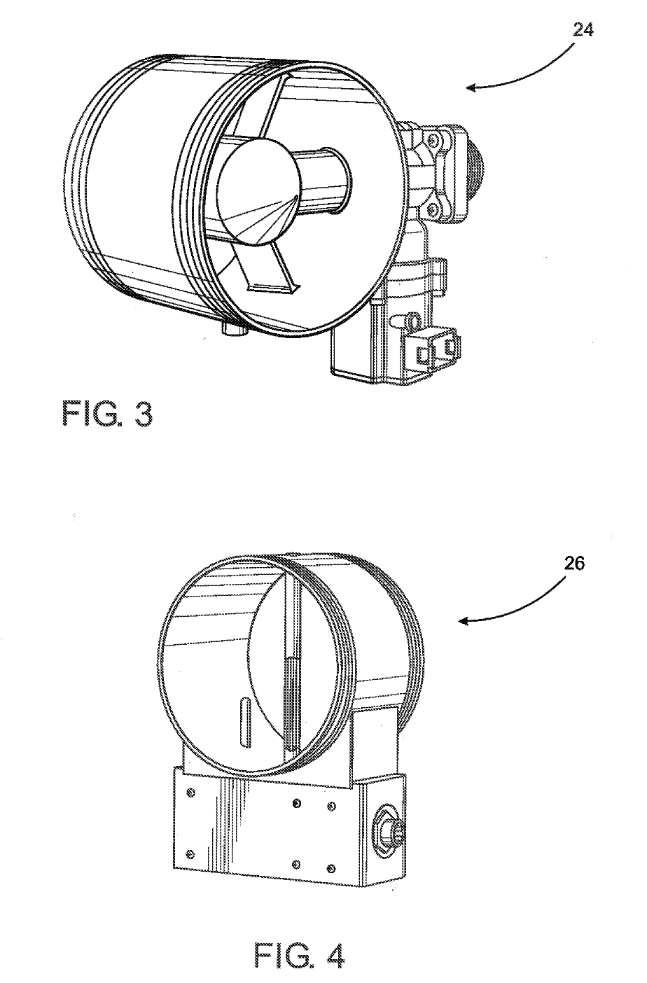

As represented in FIG. 3 a low-pressure natural gas is applied to the engine using a fumigation method whereby gaseous fuel is admitted upstream to the turbo compressor inlet using a fixed geometry air gas mixing device 24. The air gas mixer 24 will be a derivative of existing proprietary designs and modified for easy installation on be power plants of the locomotives. The air gas mixer will be constructed of high grade material protected by corrosion resistant hard anodized finish. Low-pressure natural gas is supplied to the air gas mixture using a predetermined threaded inlet port, where in the air gas mixture is associated with an integrated mass airflow (MAF) sensor 26, as represented in FIG. 4. More specifically, the mass air flow sensor provides combustion air flow data to the ECU. The MAF sensor data is utilized for gas mapping and control as well as for engine safety. The MAF sensor data is utilized by the ECU to ensure that the air-gas mixture supplied to the power plant remains below lower flammable limits (LFL).

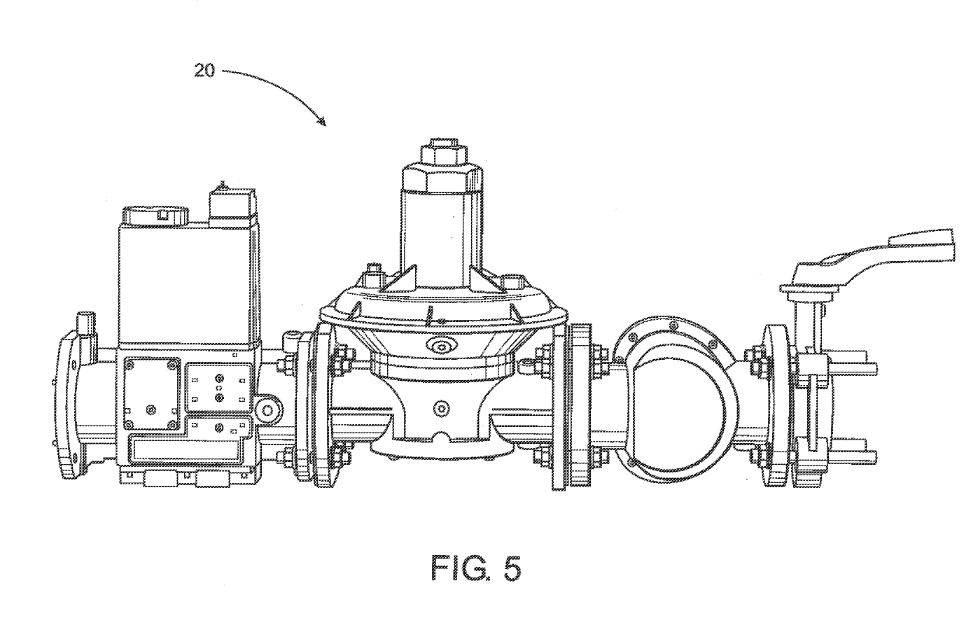

The system of the present invention includes a complete gas train 28, as represented in FIG. 5. The gas train 28 comprises a manual shutoff, 40μ gas filter, high pressure gas regulator, high-pressure gas solenoid valve, low-pressure gas regulator and gas throttle-body controller. The gas train 28 utilizes flanged connections and incorporates various pressure and temperature sensors that will provide gas pressure and temperature data to the ECU.

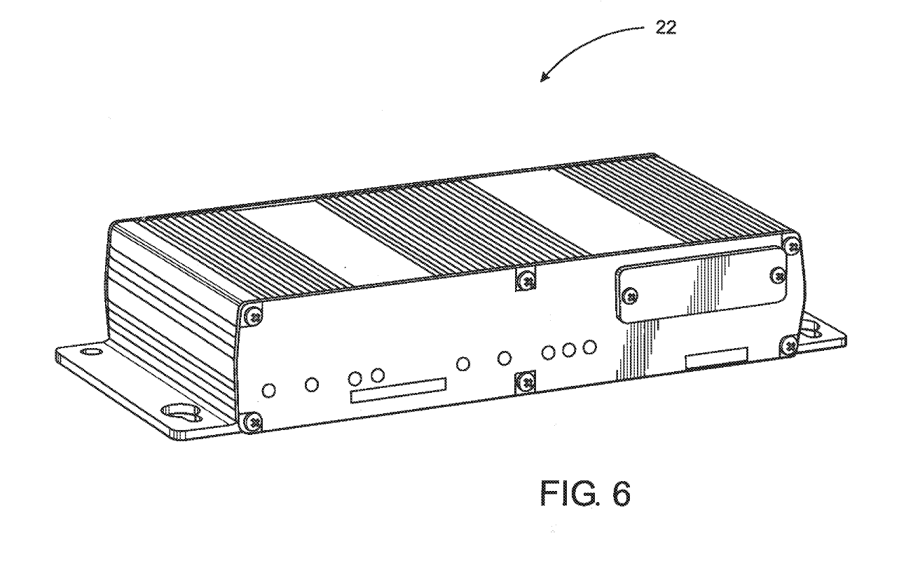

As represented in FIG. 6, the system of the present invention includes a comprehensive engine safety system 30 designed to protect against damages related to dual fuel operation. The various sensors associated there with provide data to the ECU using analog, frequency, digital, J 1939 Can and thermocouple inputs. The engine safety system 30 includes the following elements: 16 channel knock detection system; 16 channel exhaust gas temperature monitoring system; 4 channel engine vibration monitoring system; engine speed sensor; manifold air temperature sensor; manifold air pressure sensor; engine coolant temperature sensor and crankcase pressure sensor. Further, the operator safety system is designed to protect personnel from hazards associated with dual fuel operation. The various sensors provide data to the ECU and includes the following elements: operator E stop; for channel fire detection system; for channel combustion gas detection system; crankcase cover explosion relief valves and acceleration/D acceleration/role sensor.

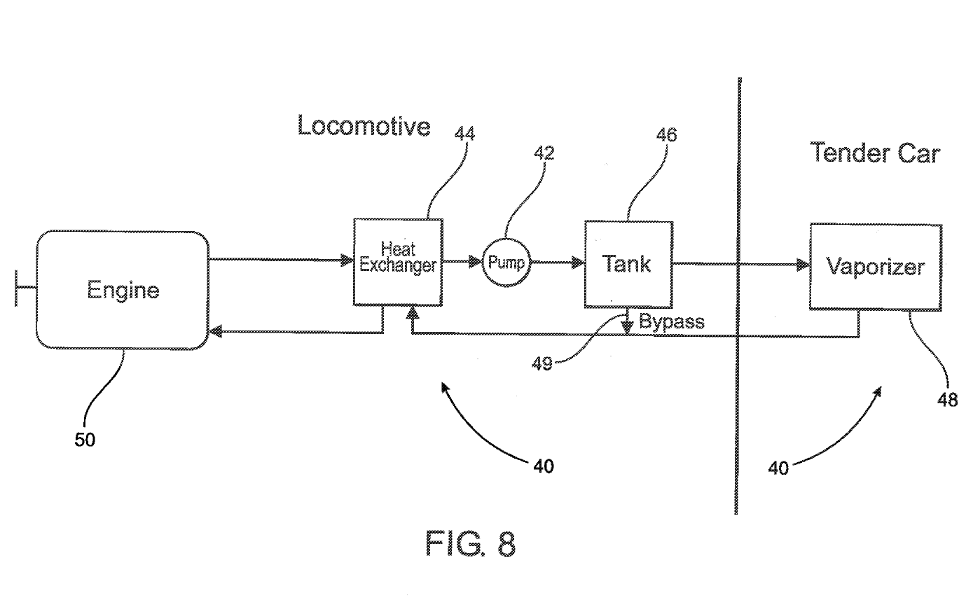

In addition to the above, the system includes a vaporizer heating fluid system generally indicated as 40 in FIG. 8. The vaporizer heating fluid system may be carried by a tender associated with the locomotives. As such a supply of LNG may also be mounted on the tender in direct communicating relation with the vaporizer heating fluid system. The vaporizer heating fluid system 40 is operative to control a water-glycol circuit for vaporization of liquid natural gas on board the tender car. The vaporizer heating fluid system 40 is controlled by the ECU 20 and comprises the following elements: heating loop pump 42; heating loop electric motor; heat exchanger 44; 25 gallon heating loop reservoir 46 and air actuated valves, thermostatic valves, temperature sensors and pressure sensors, all cooperatively disposed and operative to determine fluid flow of the LNG to and throughout the vaporizer heating fluid system 40. More specifically, heat directed from the engine as at 50 is delivered and/or absorbed by the heat exchanger 44. The aforementioned water-glycol circuit is driven by pump 42. As a result, LNG passes eventually to a vaporizer 48 wherein is vaporized for ultimate delivery to the power plant of the locomotive. However, if the demand for the vaporized gas is insufficient to require additional supply thereof, a bypass as at 49 is provided so as to redirect LNG from the tank 46 back to the heat exchanger for recirculation and eventual vaporization when required.

The system of the present invention also includes a diesel oxidation catalyst (DOC) designed as a direct replacement for the existing AC 4400 muffler. The DOC is designed and sized to meet the 10 TPA back pressure requirement. The DOC includes required hardware for installation including gaskets, bolt and ring. The DOC is monitored by the ECU for inlet temperature and inlet/outlet pressure differential. The DOC is designed and sized to reduce expected dual fuel CO emissions by approximately 90% based on the lowest target CO emissions per the notch 8 data. Estimated dual fuel CO emissions are derived using the assumption of 20× tear 0 baseline diesel levels.

| | CO | HC | NOx | PM |
|---|---|---|---|---|
| Tier 0 Highest - Notch 8 (Diesel) | 0.84 g/hp-hr | 0.23 g/hp-hr | 5.47 g/hp-hr | 0.05 g/hp-hr |
| “Estimated Dual Fuel Base | 18.2 g/hp-hr | 2.3 g/hp-hr | — | — |
| Engine Levels (Per GFS)” | | | | |
| Tier 1 + Lowest - Notch 8 Target | 0.87 g/hp-hr | 0.2 g/hp-hr | 5.46 g/hp-hr | 0.07 g/hp-hr |
| % Reduction required at Notch 8 | 95% | — | — | — |
| DOC % Reduction Achievable | 95% | TBD | — | — |

The system of the present invention further includes a fuel measurement system that monitors and records real-time consumption of diesel fuel and natural gas. The diesel fuel measurement system utilizes dual flowmeters (inlet and return) in order to calculate net consumption (A−B). The fuel measurement system provides data to the ECU using analog and/or J 1939 inputs. The ECU utilizes diesel fuel and natural gas consumption data for control and safety purposes as well as for data logging in order to track vehicle efficiency and cost savings. The ECU compares natural gas flow rates combustion mass airflow rates to ensure that gas airflow mixture supplied to the powerplant remains below lower flammable limits (LFL).

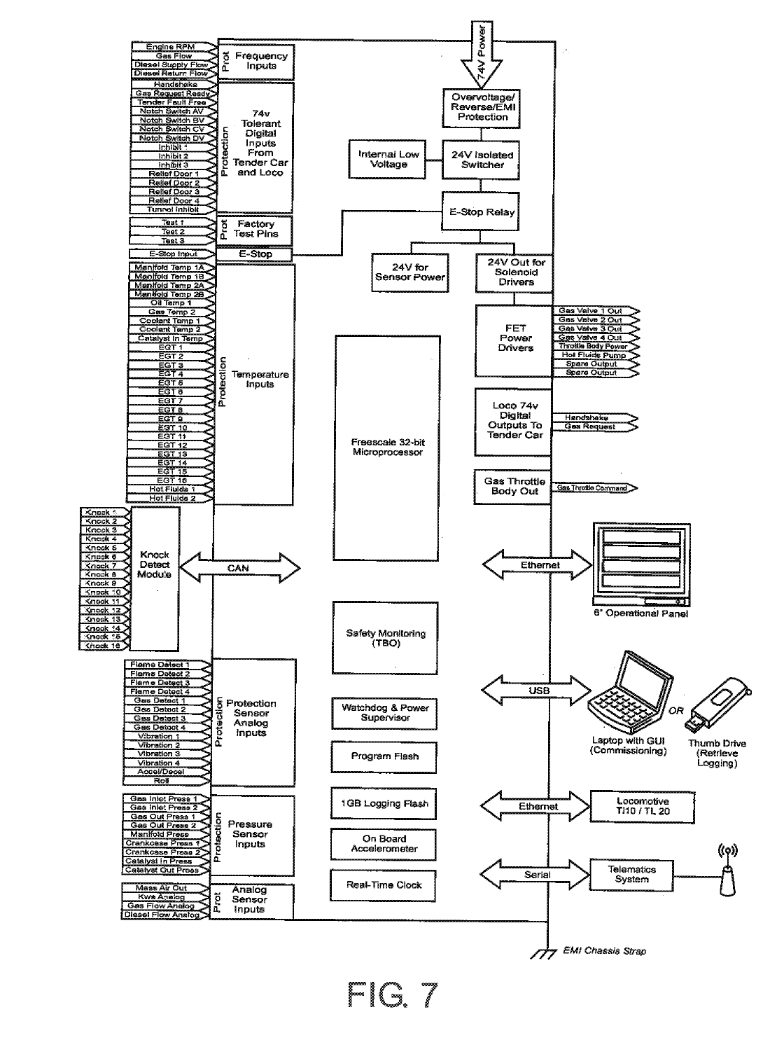

The system of the present invention further includes telematics system that interface with the ECU and provide remote monitoring capability utilizing commercial cellular networks. With reference to FIG. 7, an overview of the internal controller functions are represented.

In addition to the above the ECU provides 32 analog inputs. These are 0-5V or 4 to 20 mA signals capable of being digitized into at least 1024 different levels (10 bit A/D). Inputs have a pull-up down resistor for fault detection along with ESD protection and over/under voltage protection the active range for each input is represented in the following table:

| Quantity | Description | Signal range | |
|---|---|---|---|
| 4 | Flame Detector Sensors | 4 to 20 | mA |
| 4 | Gas Detect Sensors | 4 to 20 | mA |
| 4 | Vibration Sensors | 4 to 20 | mA |
| 2 | Acceleration/Deceleration/Roll Sensor | 4 to 20 | mA |
| 1 | Mass Air Flow Sensor | 0.5 to 4.5 | V |
| 1 | KWe Analog Sensor | 0.5 to 4.5 | V |
| 1 | Gas Flow Analog Sensor | 0.5 to 4.5 | V |
| 1 | Diesel Flow Analog Sensor | 0.5 to 4.5 | V |
| 2 | Gas Supply Pressure (GSP) | 0.5 to 4.5 | V |
| 2 | Gas Outlet Pressure (GOP) | 0.5 to 4.5 | V |
| 1 | Manifold Air Pressure (MAP) | 0.5 to 4.5 | V |
| 2 | Crankcase Pressure Sensors | 0.5 to 4.5 | V |
| 2 | Catalyst Pressure Sensors | 0.5 to 4.5 | V |
| 5 | Spare Analog Input | 0.5 to 4.5 | V |
| 32 | Total Analog Inputs | | |

Signals outside the active range will be considered fault conditions. Redundancies provided on gas case pressure inputs.

The ECU will provide for frequency inputs. These are 0-5 V signals operating in the ranges described in the following table. Inputs have a pull-up resistor for fault detection along with ESD dig decoupling and over/under voltage protection.

The allocation of frequency inputs are defined as:

| | | | Measurement | Voltage |
|---|---|---|---|---|
| Quantity | Description | Type | Range | Signal range |
| 1 | Engine RPM | Frequency | 0 to 3000 Hz | Variable |
| | | | | Reluctance |
| | | | | Pickup |
| 1 | Gas Flow Pulse | Frequency | 0 to 1000 Hz | 0-5 V |
| 1 | Diesel Flow | Frequency | 0 to 1000 Hz | 0-5 V |
| | Supply Pulse | | | |
| 1 | Diesel Flow | Frequency | 0 to 1000 Hz | 0-5 V |
| | Return Pulse | | | |
| 4 | Total Frequency | Frequency | | 0-5 V |
| | Inputs | | | |

The ECU provides 22 digital inputs. These are 0-72V input signals that have ESD decoupling and over/under voltage protection. The allocation of digital inputs are defined as:

| | | | Voltage |
|---|---|---|---|
| Quantity | Description | Conditional | Signal range |
| 1 | Tender Handshake | Low = <25 V | |
| High = >40 V | 0-72 V | | |
| 1 | Tender Gas Ready | Low = <25 V | |
| High = >40 V | 0-72 V | | |
| 1 | Tender Fault Free | Low = <25 V | |
| High = >40 V | 0-72 V | | |
| 4 | Notch Switches | | 0-72 V |
| 1 | E-stop | Open = E-stop | 0-72 V |
| 3 | Inhibit Switches | Open = Gas | 0-72 V |
| | | Inhibit | |
| 4 | Relief Door Switches | Open = Relief | 0-72 V |
| | | Active | |
| 1 | Tunnel Inhibit Input | Low = <25 V | |
| High = >40 V | 0-72 V | | |
| 3 | Factory Test Inputs | TBD | 0-72 V |
| 3 | Spares | TBD | 0-72 V |
| 22 | Total Digital Inputs | | |

The ECU provides 30 thermocouple inputs. These inputs except type K thermocouples, then amplify and condition the signals appropriately. The inputs have a detection circuit for open conditions. Redundancies provided for the manifold, gas and coolant temperature inputs. The allocation of thermocouple inputs are defined as:

| Quantity | Description | Voltage Signal range |
|---|---|---|
| 4 | Manifold Temperature | Type K |
| 2 | Gas Temperature | Type K |
| 2 | Coolant Temperature | Type K |
| 1 | Catalyst Inlet Temperature | Type K |
| 16 | Exhaust Gas Temperature | Type K |
| 2 | Hot Liquids Temperature | Type K |
| 3 | Spare Temperature | Type K |
| 30 | Total Thermocouple Inputs | |

The ECU provides an analog output to the gas throttle body. The output has protection against electrostatic discharge as well as accidental connection to the supply power or ground. This output is dedicated and configured as:

| Quantity | Description | Current Range |
|---|---|---|
| 1 | Gas Throttle Output | 0 to 5 v |
| 1 | Spare Analog Output | 0 to 5 v |
| 2 | Total Analog Outputs | |

The ECU provides power output (on/off) to control the gas valves and hot fluids pump and to provide power to the throttle body. The outputs have a fly-back protection diode and are protected against electrostatic discharge, as well as accidental connection to supply or ground. They utilized 24V power that is created from the 72V power supply input. Outputs are dedicated and configured as:

| Quantity | Description | Current Range |
|---|---|---|
| 1 | Throttle Body 24 v Power | 5 Amp maximum |
| 4 | Gas Solenoid 24 v Outputs | 2 Amp maximum |
| 1 | Hot Fluids Pump 24 v Power | 2 Amp maximum |
| 2 | Spare 24 v Power | 2 Amp maximum |
| 8 | Total Power Driver Outputs | |

The power outputs have internal feedback capabilities that allow for fault detection on the outputs in conjunction with being able to automatically shut off on thermal overload conditions.

The ECU provides two 72V outputs to communicate with the locomotive/tender car 2 spares will also be included for future expansion.

The allocation of discrete outputs are defined as:

| Quantity | Description | Current Range |
|---|---|---|
| 1 | Tender Handshake | 0.1 Amp maximum |
| 1 | Tender Gas Request | 0.1 Amp maximum |
| 2 | Spare 72 v Discrete | 0.1 Amp maximum |
| 4 | Total Discrete Outputs | |

The EC provides non-volatile memory storage for coding calibration parameters. Sufficient memory is provided to leave an estimated 70% reserve for future expansion. Paragraph non-volatile memory is provided to store up to 1 GB of blogging. The data logs are critical system parameters per a defined rate, as well as upon the occurrence of any fault elements. Paragraph ECU provides 5 communication links. These links include wired Ethernet for train link; wired Ethernet for operator panel communications; universal serial bus (USB); RS-232 serial port telematics system and J 1939 CAN for knock detection module.

The communications link between the locomotives ECU and the tender cars hot fluids controller utilizes Ethernet converted through a train line converter. This IEEE 802.3 Ethernet port will support 10/100 Mbps speeds and will be transformer coupled.

The operator panel communicates with the locomotive gas control through a 2^{nd} wired ethernet link. The IEEE 802.3 ethernet port supports 10/100 Mbps speeds and is transformer coupled. The USB implementation provides a connection between a USB port in the cab and ECU. The USB port is used for 2 purposes: communicate with a laptop during commissioning and configuration Karen See FIG. 7 and downloading logging files to a thumb drive, See FIG. 7. The USB connection supports USB 2.0 speeds the final cable length is Below 20 feet. Otherwise, the throughput will degrade to USB 1.1 speed. USP channel is isolation from the ECU power supplies.

Periodic data (2 Second rate) is transferred to the telematics system of the RS 232 serial port. Serial baud rates up to 115.2 K bps are supported. The serial channel has isolation from ECU power supplies.

The knock detection system communicates with the ECU over the CAN serial data link. The ECU provides power for this module. The CAN channel is isolated from the ECU power supplies.

The ruggedized dual fuel locomotive ECU has a power supply that operates from 40-90 VDC locomotive power. It is designed to provide clean power to the ECU internal circuitry that is limited, filtered and transient protected from the vehicle power supply. The ECU power grounds are electrically isolated from its enclosure (chassis ground) to meet both safety and EMI design requirements. The ECU design incorporates internal power supplies that will provide short-circuit protection, thermal limiting, reverse voltage protection, and load dump protection up to 200V. The design also includes the necessary filtering components to minimize emissions, both conducted and radiated. The ECU is designed to be resistant to EMI/EMC, load dump, over-power, and over-temperature conditions.

An important function of the power supply circuitry is to monitor the voltage supplied to the digital logic. On power-up the power supply holds the microcontroller and all outputs in “reset” until the digital logic supplies stabilized and is within tolerances. This technique ensures that the microcontroller clocks and memory devices are functional before the microcontroller starts to execute software. Conversely, the power supply must also learn the microcontroller when it senses that the vehicle battery supply is starting to drop, as occurs when the unit is turned off. The supply warns the microcontroller by issuing a high priority interrupt. When the interrupt is activated, the microcontroller has a fraction of a second to terminate any data rights to memory and to form an orderly shutdown of all outputs. This ensures that all outputs are held in a safe state until “reset” has been completed and the system is returned to normal operating conditions.

The ECU utilizes an automotive-grade 32-bit microcontroller that provides excellent performance over temperature ranges for rugged vehicle applications.

The ECU contains a real-time clock that is utilized to time-stamp the data logging. It has an alternate internal supply to keep the real-time clock operating through unpowered conditions, such as maintenance downtimes.

The PCB uses a mixture of surface mount technology (SMT) and through-hole components, as appropriate. The PCB is designed to protect the electronic components in a shock and vibration environment. Components are securely fastened to the PCB. Surface mount components are used wherever possible. The axial leaded parts are used in place of radial leaded components, as deemed appropriate. The proposed PCB is fabricated from FR4 material.

Is emphasized that while the system of the present invention is primarily described with reference to the bi-fuel (diesel and LNG) operation of a power plant associated with a single locomotive, the system includes structural and operational versatility sufficient to control such bi-fuel operation of more than one locomotive wherein a tender, as described above, may be directly associated with a single locomotive and or more than one locomotive.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A system for the control of bi-fuel operation of a locomotive power plant, said system comprising:
an electronic control unit (ECU) structured to manage liquid natural gas fueling rates based on predetermined information associated with operation of the locomotive power plant,
a vaporization heating fluid system structured to control vaporization of the LNG delivered to the locomotive power plant, said vaporization heating fluid system controlled by said ECU, said ECU receptive of power plant operating characteristic inputs in determining the rate of vaporization and control of vaporized LNG to the locomotive power plant, and
a fuel measurement system structured to monitor and record real-time consumption of both diesel fuel and LNG.

2. A system as recited in claim 1, wherein a supply of LNG and said vaporization heating fluid system is carried on a tender associated with the locomotive.

3. A system as recited in claim 1 wherein said vaporizer heating fluid assembly is structured to control a locomotive hot fluid system comprising a water-glycol circuit determinative of the rate of vaporization of said LNG, as controlled by said ECU.

4. A system as recited in claim 3 wherein said vaporizer heating fluid system comprises a heat exchanger, a heating Loop reservoir and a plurality of actuation valves facilitating flow of LNG through said heat exchanger for determination of a rate of vaporization.

5. A system as recited in claim 4 wherein said vaporizer heating fluid system is operative based on input from both temperature sensors and pressure sensors and a differential of temperature and pressure of an input/output of the heat exchanger.

6. A system as recited in claim 5 wherein an output of vaporized LNG from said vaporizer heating fluid system is determined by input to said ECU.

7. A system as recited in claim 1 further comprising a diesel oxidation catalyst (DOC) structured to accommodate predetermined back pressure requirements and including a monitored interconnection with said ECU for determination of inlet temperature and inlet/outlet pressure differential.

8. A system as recited in claim 7 wherein said DOC is structured to reduce CO omissions generated by dual fuel operation of the locomotive power plant.

9. A system as recited in claim 8 wherein said DOC is structured to reduce expected dual fuel CO emissions by approximately 95% based on lowest target CO omissions per notch 8 data determined by said ECU.

10. A system as recited in claim 9 wherein estimated fuel CO emissions are derived based on an assumption of 20× Tier 0 baseline diesel levels.

11. A system as recited in claim 1 further comprising a fuel measurement system structured to monitor and record real-time consumption of defined by fuel supply including diesel and LNG.

12. A system as recited in claim 11 wherein said fuel measurement system provides data to the ECU using at least one of analog and J 1939 inputs.

13. A system as recited in claim 12 wherein said ECU utilizes diesel fuel and LNG consumption data for control and regulation of said fuel measurement system; said diesel fuel and LNG consumption data being indicative of vehicle efficiency and cost savings over a predetermined distance of travel.

14. A system as recited in claim 13 wherein said ECU is structured to compare LNG flow rates with combustion mass air flow rates to ensure that and air-gas mixture supplied to the locomotive power plant remains below lower flammable limits.

15. A system as recited in claim 1 further comprising a telematics system structured to interface with said ECU and provide remote monitoring capabilities.

16. A system as recited in claim 15 wherein said remote monitoring capabilities are determined utilizing cellular networks.

17. A system as recited in claim 1 wherein said ECU is operative to monitor power plant parameters including pre-alarm, alarm, warning alarm and fault modes.

18. A system as recited in claim 1 wherein said ECU is operative to decrease LNG flow rates in response to predetermined critical parameters.

19. A system as recited in claim 18 wherein said predetermined critical parameters include knock, vibration, manifold air pressure and EGT.

20. A system as recited in claim 19 wherein said ECU is further operative to manage said fluid locomotive system and is communicative with a tender associated with the locomotive.

21. A system as recited in claim 1 wherein said ECU comprises a power supply operative using locomotive power ranging from 40-90V/DC.

22. A system as recited in claim 1 wherein said ECU is operative to apply low-pressure LNG using a fumigation method administered by a fixed geometry air gas mixer.

23. A system as recited in claim 22 wherein said air-gas mixer is operatively associated with an integrated mass airflow sensor.

24. A system as recited in claim 23 wherein said mass airflow sensor is structured to generate airflow data transmitted to said ECU.

25. A system as recited in claim 23 wherein said mass airflow sensor is operative to ensure the determined air-gas mixture flow from said air-gas mixer is below acceptable lower flammable limits.

26. A system as recited in claim 1 further comprising an engine safety system structured to protect against changes related to bi-fuel operation.

27. A system as recited in claim 26 wherein said engine safety system is operative based on inputs to said ECU including analog input, frequency input, digital input, J 1939 input and thermocouple input.

28. A system as recited in claim 26 wherein said engine safety system further comprises a knock detection system, exhaust gas temperature monitoring system, engine vibration monitoring system, engine speed sensor, manifold air temperature sensor, manifold air pressure sensor, engine control temperature sensor and crankcase pressure sensor.
